(19) United States
(12) Patent Application Publication
(10) Pub. No.: US 2026/0323187 A1
(43) Pub. Date: Oct. 15, 2026

(54) PHOTOELECTRIC CONVERSION DEVICE

(71) Applicant: CANON KABUSHIKI KAISHA, Tokyo (JP)

(72) Inventor: SHINYA IGARASHI, Kanagawa (JP)

(21) Appl. No.: 19/636,159

(22) Filed: Apr. 1, 2026

(30) Foreign Application Priority Data
Apr. 15, 2025 (JP) 2025-066959

(51) Int. Cl. H04N 25/76; H04N 25/773; H04N 25/779

(52) U.S. Cl. CPC H04N 25/7795; H04N 25/773; H04N 25/779

(57) ABSTRACT

The photoelectric conversion device includes a plurality of pixels each including an avalanche photodiode, a charge circuit, and a counter, and a scanning circuit configured to supply a charge pulse and a readout signal to the pixels in each row. The charge circuit sets the avalanche photodiode to a charge state or a floating state. The counter counts a signal of the avalanche photodiode in a floating state. A difference between a timing at which the supply of the charge pulse to the pixels in a first row is started and a timing at which the supply of the charge pulse to the pixels in a second row is started corresponds to a difference between a timing at which the readout signal is supplied to the pixels in the first row and a timing at which the readout signal is supplied to the pixels in the second row.

### BACKGROUND

### Field of the Technology

The present disclosure relates to a photoelectric conversion device.

### Description of the Related Art

A photoelectric conversion device capable of detecting a single photon using an avalanche photodiode (APD) is known. The photoelectric conversion device disclosed in Japanese Patent Laid-Open No. 2023-159648 supplies a pulse signal to pixels in each row and sets one node of the APD to a floating state or a charge state. A counter counts a signal by avalanche multiplication of the APD in the floating state. A scanning circuit supplies a readout signal to the pixels in each row, and the pixels receive the readout signal and output the count value of the counter to a readout circuit. Since the pixels do not have a memory, the scanning circuit supplies the readout signal to the pixels in each row so that the count value of the previous frame is output before the pulse signal for the next frame is supplied.

However, in the photoelectric conversion device disclosed in Japanese Patent Laid-Open No. 2023-159648, there is a problem that the accumulation period of the count value is shortened.

### SUMMARY

Therefore, the present disclosure is directed to provide a photoelectric conversion device capable of suppressing the shortening of the accumulation period of the count value.

According to one aspect of the present specification, there is provided a photoelectric conversion device that includes a plurality of pixels each including an avalanche photodiode, a charge circuit, and a counter and arranged in a matrix; and a scanning circuit configured to supply a charge pulse for controlling the charge circuit and a readout signal for reading out a count value of the counter to the pixels in each row, wherein the charge circuit is configured to set one node of the avalanche photodiode to a charge state or a floating state in response to the charge pulse supplied at a predetermined period, wherein the counter is configured to count a signal obtained by avalanche multiplication of the avalanche photodiode in the floating state, and wherein a difference between a timing at which the supply of the charge pulse to the pixels in a first row is started and a timing at which the supply of the charge pulse to the pixels in a second row is started corresponds to a difference between a timing at which the readout signal is supplied to the pixels in the first row and a timing at which the readout signal is supplied to the pixels in the second row.

According to one aspect of the present specification, there is provided a photoelectric conversion device that includes a plurality of pixels each including an avalanche photodiode, a charge circuit, and a counter and arranged in a matrix; and a scanning circuit configured to supply a charge pulse for controlling the charge circuit and a readout signal for reading out a count value of the counter to the pixels in each row, wherein in response to a synchronous signal for synchronizing the charge pulses in each row or an asynchronous signal for not synchronizing the charge pulses in each row, the scanning circuit is configured to supply the charge pulse to the pixels in each row, wherein the charge circuit is configured to set one node of the avalanche photodiode to a charge state or a floating state in response to the charge pulse supplied at a predetermined period, wherein the counter is configured to count a signal obtained by avalanche multiplication of the avalanche photodiode in the floating state, and wherein a difference between a timing of supplying the asynchronous signal to the pixels in a first row and a timing of supplying the asynchronous signal to the pixels in a second row corresponds to a difference between a timing of supplying the readout signal to the pixels in the first row and a timing of supplying the readout signal to the pixels in the second row.

Features of the present disclosure will become apparent from the following description of embodiments with reference to the attached drawings. The following description of embodiments is described by way of example.

### BRIEF DESCRIPTION OF THE DRAWINGS

FIG. 1 is an exploded perspective view of a stacked photoelectric conversion device according to a first embodiment.

FIG. 2 is a block diagram of a sensor substrate according to the first embodiment.

FIG. 3 is a block diagram of a circuit substrate according to the first embodiment.

FIG. 4 is a block diagram of a pixel according to the first embodiment.

FIG. 5 is a timing chart illustrating an operation of a pixel according to the first embodiment.

FIG. 6 is a timing chart illustrating an operation of a photoelectric conversion device according to the first embodiment.

FIG. 7 is a block diagram of a pixel according to a second embodiment.

FIG. 8 is a timing chart illustrating an operation of a pixel according to the second embodiment.

FIG. 9 is a block diagram of a circuit substrate according to the second embodiment.

FIG. 10 is a diagram illustrating conditions for switching between an in-phase mode and an out-of-phase mode according to the second embodiment.

FIG. 11 is a timing chart illustrating an operation of a photoelectric conversion device in the in-phase mode according to the second embodiment.

FIG. 12 is a timing chart illustrating an operation of a photoelectric conversion device in the out-of-phase mode according to the second embodiment.

FIG. 13 is a block diagram of a circuit substrate according to a third embodiment.

FIG. 14 is a timing chart illustrating an operation of a photoelectric conversion device according to the third embodiment.

FIG. 15 is a block diagram of an equipment according to a fourth embodiment.

FIGS. 16A and 16B are block diagrams of an equipment according to a fifth embodiment.

### DESCRIPTION OF THE EMBODIMENTS

### First Embodiment

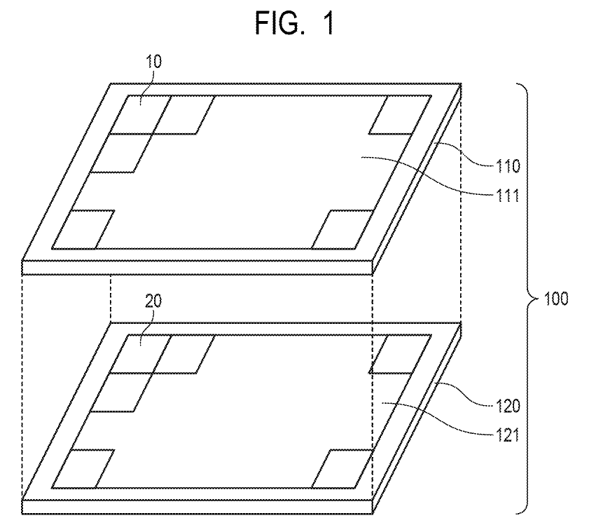

FIG. 1 is an exploded perspective view of a stacked photoelectric conversion device 100 according to the present embodiment. In the photoelectric conversion device 100, two semiconductor substrates of a sensor substrate 110 and a circuit substrate 120 are stacked and electrically connected to each other. The sensor substrate 110 has a pixel region 111, and the circuit substrate 120 has a circuit region 121. In a state in which the sensor substrate 110 and the circuit substrate 120 are stacked, the photoelectric conversion device 100 includes a plurality of pixels. Each pixel includes a photoelectric conversion unit 10 and a signal processing unit 20. The photoelectric conversion unit 10 is provided in the pixel region 111, and the signal processing unit 20 is provided in the circuit region 121.

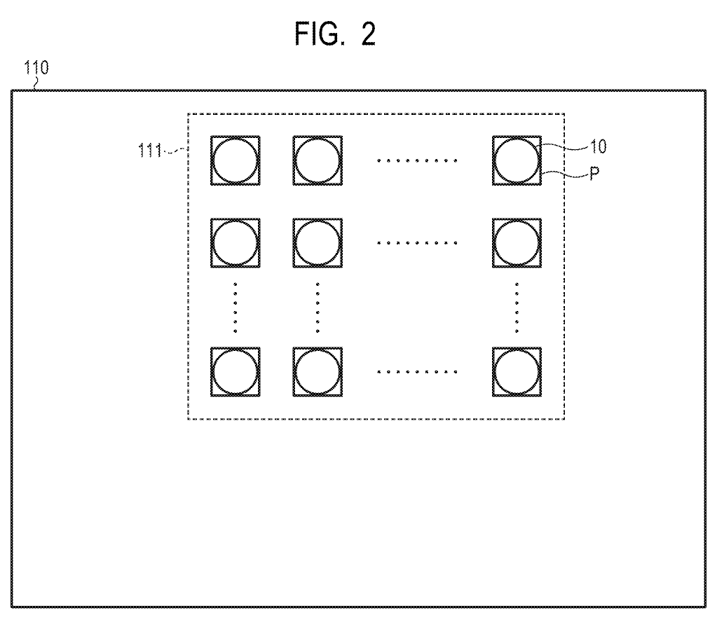

FIG. 2 is a block diagram of the sensor substrate 110 according to the present embodiment. In the pixel region 111 of the sensor substrate 110, the photoelectric conversion units 10 of the pixels P are arranged in a two-dimensional array in plan view. The arrangement of the photoelectric conversion units 10 in the pixel region 111 may be one-dimensionally arranged.

Although the pixel P is typically used to generate an image, the pixel P may not necessarily generate an image when used in Time of Flight (TOF). That is, the pixel P may be configured to measure the time of arrival of light and the amount of light.

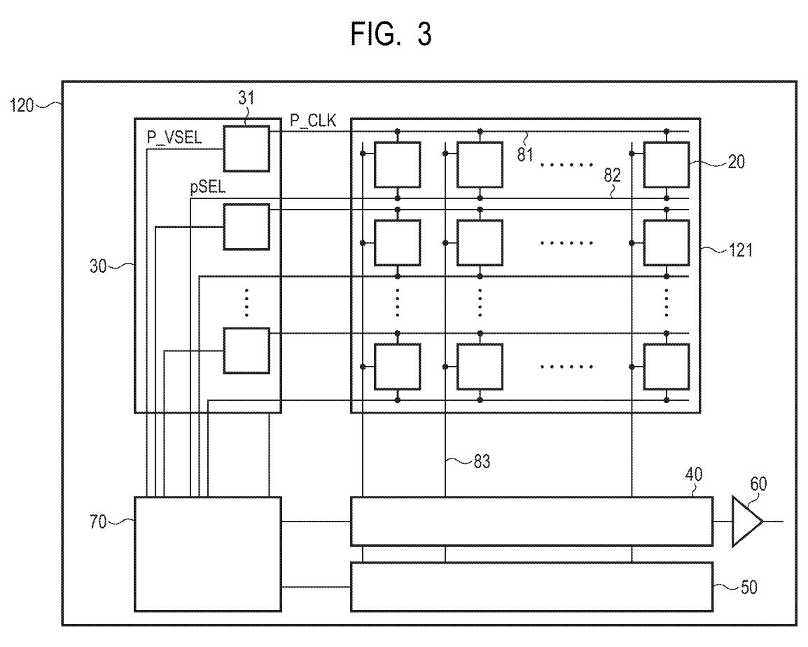

FIG. 3 is a block diagram of the circuit substrate 120 according to the present embodiment. In the circuit region 121 of the circuit substrate 120, the signal processing units 20 are arranged in a two-dimensional array in plan view. The pixel region 111 and the circuit region 121 overlap each other in a plan view, and the photoelectric conversion unit 10 and the signal processing unit 20 correspond to each other in each pixel P. The signal processing unit 20 is connected to the photoelectric conversion unit 10 via wiring provided for each pixel P. The plurality of pixels P are arranged in a matrix (array).

In each row of the pixel array of the circuit substrate 120, control lines 81 and 82 extend in a first direction (lateral direction in FIG. 3). The control lines 81 and 82 are connected to the signal processing units 20 arranged in the first direction, respectively, and form common signal lines for the signal processing units 20. The signal processing units 20 arranged in the same row are controlled by the same control lines 81 and 82. Each of the control lines 81 and 82 may include a plurality of signal lines for supplying a plurality of types of control signals to the signal processing unit 20.

In each column of the pixel array of the circuit substrate 120, the data lines 83 extend in a second direction (vertical direction in FIG. 3) intersecting the first direction. The data line 83 is connected to the signal processing units 20 of the pixels P arranged in the second direction, respectively, and forms a common signal line for the signal processing units 20. Each of the data lines 83 may include a plurality of signal lines for transferring a digital signal of a plurality of bits output from the signal processing unit 20 in parallel for each bit.

The circuit substrate 120 includes a vertical scanning circuit (scanning circuit) 30, a readout circuit 40, a horizontal scanning circuit 50, an output circuit 60, and a control circuit 70. These circuits are arranged in a region around the circuit region 121 in the circuit substrate 120.

The vertical scanning circuit 30 includes a plurality of generation units 31. Each of the generation units 31 is disposed for one or more rows of the pixel array. For example, each of the generation units 31 is disposed for one row of the pixel array. A generation unit 31 starts generation of a pulse P_CLK (charge pulse) in response to a control signal P_VSEL from the control circuit 70. Here, the control signal P_VSEL is used to select a row from which the supply of the pulse P_CLK is started among rows of the pixel array. The pulse P_CLK is for supplying a charge current to the photoelectric conversion unit 10. The generation unit 31 includes a frequency dividing circuit, and the frequency dividing circuit generates the pulse P_CLK by dividing the frequency of a clock for driving the photoelectric conversion device 100. Each generation unit 31 supplies the pulse P_CLK to the signal processing unit 20 of the pixel P in the corresponding row. The pulse P_CLK is supplied to the pixels P in each row at a predetermined period.

The vertical scanning circuit 30 further receives a control signal pSEL (readout signal) from the control circuit 70, and supplies the control signal pSEL to the signal processing unit 20 of the pixels P in each row. The control signal pSEL is for reading out a pixel signal from the signal processing unit 20. The control signal pSEL is supplied to the signal processing unit 20 via the control line 82.

The readout circuit 40 includes a plurality of holding units (not illustrated) provided for each column of the pixel array. The readout circuit 40 holds the pixel signal of the pixel P of each column output for each row of the pixel array in the holding unit of the corresponding column.

The horizontal scanning circuit 50 receives a control signal from the control circuit 70, sequentially scans the holding units of each column of the readout circuit 40, and causes the holding units to sequentially output pixel signals to the output circuit 60. The horizontal scanning circuit 50 may include a logic circuit such as a shift register and an address decoder.

The output circuit 60 includes an external interface circuit, and outputs the pixel signal output from the readout circuit 40 to the outside of the photoelectric conversion device 100. The external interface circuit included in the output circuit 60 is not limited to any particular configuration. A SerDes (SERializer/DESerializer) transmission circuit is applicable to the external interface circuit. As the SerDes transmission circuit, for example, an LVDS (Low Voltage Differential Signaling) circuit, an SLVS (Scalable Low Voltage Signaling) circuit, or the like can be applied.

The control circuit 70 generates a control signal for controlling operations and timings of the vertical scanning circuit 30, the readout circuit 40, and the horizontal scanning circuit 50, and supplies the control signal to each circuit block. For example, the control circuit 70 supplies the control signals P_VSEL and pSEL to the vertical scanning circuit 30. At least a part of the control signal may be supplied from the outside of the photoelectric conversion device 100.

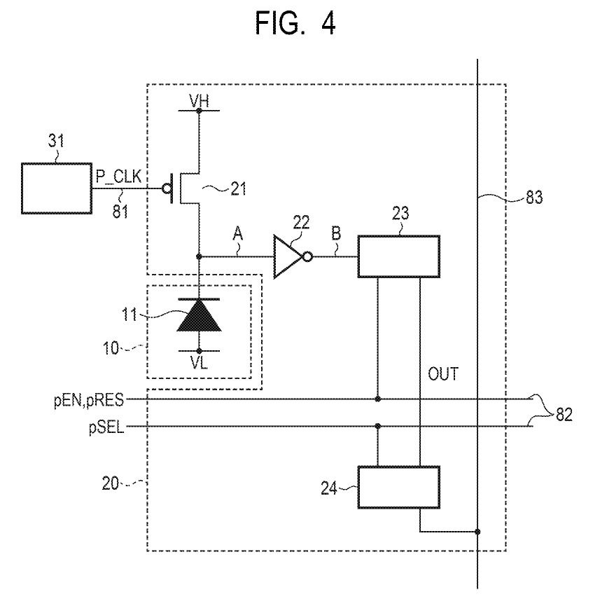

FIG. 4 is a block diagram of the pixel P according to the present embodiment. In the pixel P, the photoelectric conversion unit 10 includes an avalanche photodiode (APD) 11, and the signal processing unit 20 includes a switch (charge circuit) 21, a waveform shaping circuit 22, a counter 23, and a selection circuit 24.

The anode of the APD 11 is connected to a power supply node that supplies a voltage VL (for example, -30 V). The cathode of the APD 11 is connected to one terminal of the switch 21. A connection node between the APD 11 and the switch 21 is an output node of the photoelectric conversion unit 10. The other terminal of the switch 21 is connected to a power supply node that supplies a voltage VH (e.g., 1 V) higher than the voltage VL. The voltage VL and the voltage VH are set to be reverse bias voltages that cause the APD 11 to induce avalanche multiplication. Here, a negative high voltage is supplied as the voltage VL, and a positive voltage that is approximately equal to the power supply voltage is supplied as the voltage VH.

When a reverse bias voltage is applied between the anode and the cathode of the APD 11, carriers generated by light incident on the APD 11 cause avalanche multiplication, and an avalanche current is generated. The operation modes in a state where a reverse bias voltage is applied to the APD 11 include a Geiger mode and a linear mode. The Geiger mode is an operation mode in which the reverse bias voltage is set to a voltage higher than the breakdown voltage of the APD 11. The linear mode is an operation mode in which the reverse bias voltage is set to a voltage around or below the breakdown voltage of the APD 11. The APD 11 operated in the Geiger mode is called SPAD (Single-Photon Avalanche Diode). The photoelectric conversion device 100 may operate in either the Geiger mode or the linear mode.

The switch 21 functions as a load circuit (quench circuit) during avalanche multiplication, and reduces the reverse bias voltage applied to the APD 11 to suppress avalanche multiplication. The operation in which the switch 21 suppresses avalanche multiplication is called a quench operation. Further, the switch 21 returns the voltage applied to the APD 11 to a reverse bias voltage capable of avalanche multiplication by causing a current corresponding to the voltage drop due to the quench operation to flow through the APD 11. The operation in which the switch 21 returns the voltage to the reverse bias voltage is called a charge operation, and the current supplied to the APD 11 in the charge operation is called a charge current.

In the present embodiment, the switch 21 is configured by a PMOS transistor, and the pulse P_CLK is periodically input from the generation unit 31 to the gate of the PMOS transistor. The PMOS transistor is turned on or off by the pulse P_CLK, and the electrical connection between the power supply node and the cathode of the APD 11 is connected or disconnected. When the PMOS transistor is turned on, a charge current is supplied from the power supply node to the cathode of the APD 11. When the PMOS transistor is turned off, the supply of the charge current from the power supply node to the cathode of the APD 11 is stopped, and the cathode of the APD 11 enters a floating state.

The waveform shaping circuit 22 includes an inverter circuit (NOT circuit) and includes a node A and a node B. An analog signal is input to the node A from the photoelectric conversion unit 10. The waveform shaping circuit 22 converts the analog signal into a pulse signal and outputs the pulse signal from the node B to the counter 23. Although the waveform shaping circuit 22 has been described as having one inverter circuit, it may be a circuit in which a plurality of inverters are connected in series, or may be another circuit having a waveform shaping effect.

The counter 23 includes an input node to which a pulse signal from the waveform shaping circuit 22 is input, a control node to which control signals from the vertical scanning circuit 30 are input, and an output node. The control signals may include an enable signal pEN for controlling the count period (exposure period) of the pulse signal, a reset signal pRES for resetting the count value of the counter 23, and the like. The counter 23 counts the pulse signal from the waveform shaping circuit 22 and holds the count value. The counter 23 outputs the count value OUT from the output node to the selection circuit 24.

The selection circuit 24 switches the electrical connection between the counter 23 and the data line 83 according to the control signal pSEL from the vertical scanning circuit 30. When the control signal pSEL is at high level, the selection circuit 24 electrically connects the counter 23 and the data line 83 to cause the counter 23 to output the count value OUT to the data line 83. When the control signal pSEL is at low level, the selection circuit 24 does not electrically connect the counter 23 and the data line 83, and does not cause the counter 23 to output the count value OUT to the data line 83. The selection circuit 24 may include a buffer circuit (not illustrated) for causing the counter 23 to output the count value OUT.

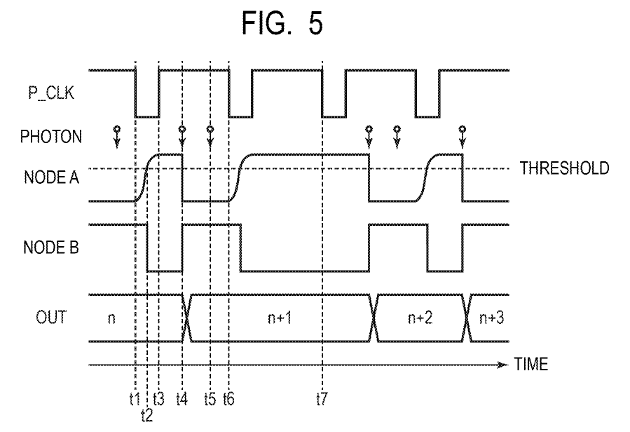

FIG. 5 is a timing chart illustrating the operation of the pixel P according to the present embodiment. FIG. 5 illustrates the pulse P_CLK, the photon, the voltage of the node A, the voltage of the node B, and the count value OUT.

At time t1, when the pulse P_CLK changes from high level to low level, the switch 21 is turned on, and the charge current is supplied from the power supply node at the voltage VH to the cathode of the APD 11 (charge state). When the charge current is supplied, the voltage of the cathode of the APD 11, that is, the voltage of the node A of the waveform shaping circuit 22 starts to rise.

At time t2, when the voltage of the node A exceeds a predetermined threshold value, the voltage of the node B of the waveform shaping circuit 22 is inverted and changes from high level to low level.

At time t3, when the pulse P_CLK changes from low level to high level, the switch 21 is turned off, and the supply of the charge current from the power supply node at the voltage VH to the cathode of the APD 11 is stopped. The cathode of the APD 11 is in a floating state. In the floating state, a reverse bias voltage (VH-VL) capable of avalanche multiplication is applied to the APD 11.

When a photon is incident on the APD 11 at time t4, electron-hole pairs are generated by photoelectric conversion. Avalanche multiplication occurs using these carriers as seeds, and an avalanche current flows through the APD 11. When the avalanche current flows, the voltage of the cathode of the APD 11, that is, the voltage of the node A drops. When the reverse bias voltage applied to the APD 11 decreases due to the voltage drop, the avalanche multiplication of the APD 11 stops, and the voltage drop of the node A stops. When the voltage of the node A becomes equal to or lower than the threshold value, the voltage of the node B of the waveform shaping circuit 22 is inverted and changes from low level to high level.

When the voltage of the node A exceeds the threshold value at time t2, the waveform shaping circuit 22 outputs a low-level signal. When the voltage of the node A becomes equal to or lower than the threshold value at time t4, the waveform shaping circuit 22 outputs a high-level signal. The signal input from the node A is waveform-shaped into a high-level signal or a low-level signal by the waveform shaping circuit 22, and is output from the node B. The counter 23 receives a high-level signal from the waveform shaping circuit 22, and counts up the count value from (n) to (n+1).

At time t5, a photon is incident on the APD 11, but since a reverse bias voltage capable of avalanche multiplication is not applied to the APD 11, avalanche multiplication does not occur.

At time t6, when the pulse P_CLK changes from high level to low level, the switch 21 is turned on, and a charge current for compensating the voltage drop is supplied from the power supply node at the voltage VH to the cathode of the APD 11 (charge state). When the charge current is supplied, the voltage of the cathode of the APD 11, that is, the voltage of the node A of the waveform shaping circuit 22 starts to rise. The operation after time t6 is the same as the operation from time t1 to t5.

At time t7, the pulse P_CLK changes from high level to low level, and the switch 21 is turned on, but the charge current is not supplied to the APD 11. This is because a reverse bias voltage capable of avalanche multiplication has already been applied to the APD 11.

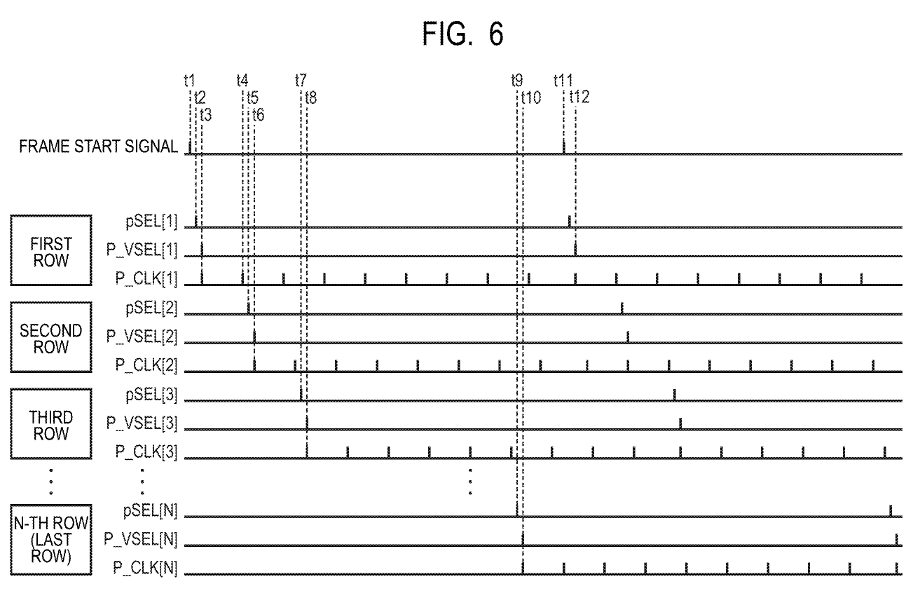

FIG. 6 is a timing chart illustrating the operation of the photoelectric conversion device 100 according to the present embodiment. FIG. 6 illustrates a frame start signal, control signals pSEL and P_VSEL, and a pulse P_CLK. The first, second, third, and N-th (last) rows among the first to N-th rows of the pixel array are illustrated. When the control signal pSEL is supplied to the first row, it is referred to as a control signal pSEL[1]. The same applies to the control signal P_VSEL and the pulse P_CLK.

At time t1, the control circuit 70 supplies a frame start signal to the vertical scanning circuit 30. The vertical scanning circuit 30 receives the frame start signal and starts generating the first frame. The frame start signal may be generated by the control circuit 70, or may be supplied to the control circuit 70 from the outside of the photoelectric conversion device 100.

At time t2, the control circuit 70 supplies the control signal pSEL[1] to the vertical scanning circuit 30. The timing of the control signal pSEL[1] can be set based on the data output rate of the output circuit 60. The vertical scanning circuit 30 supplies a control signal pSEL[1] from the control circuit 70 to the pixels P in the first row. The pixels P in the first row receive the control signal pSEL[1], and the counter 23 outputs the count value to the readout circuit 40.

At time t3, the control circuit 70 supplies the control signal P_VSEL[1] to the generation unit 31 in the first row. The generation unit 31 in the first row receives the control signal P_VSEL[1] and starts supplying the pulse P_CLK[1] to the pixels P in the first row. The switch 21 of the pixel P in the first row is turned on by receiving the pulse P_CLK[1], and a charge current is supplied from the power supply node to the cathode of the APD 11.

At time t4, the generation unit 31 in the first row supplies the pulse P_CLK[1] to the pixels P in the first row.

At time t5, the control circuit 70 supplies the control signal pSEL[2] to the vertical scanning circuit 30. The vertical scanning circuit 30 supplies the control signal pSEL[2] from the control circuit 70 to the pixels P in the second row. The pixels P in the second row receive the control signal pSEL[2], and the counter 23 outputs the count value to the readout circuit 40.

At time t6, the control circuit 70 supplies the control signal P_VSEL[2] to the generation unit 31 in the second row. The generation unit 31 in the second row receives the control signal P_VSEL[2] from the control circuit 70, and starts supplying the pulse P_CLK[2] to the pixels P in the second row. The switch 21 of the pixel P in the second row is turned on by receiving the pulse P_CLK[2], and the charge current is supplied from the power supply node to the cathode of the APD 11.

The operation of the third row at times t7 and t8 is the same as the operation in the second row at times t5 and t6. The operation of the N-th row (last row) at times t9 and t10 is the same as the operation in the second row at times t5 and t6.

At time t11, the control circuit 70 supplies a frame start signal indicating the start of generation of the second frame to the vertical scanning circuit 30. The pixels P in each row receive the control signal pSEL supplied after time t11, and output the count value of the first frame from the counter 23 to the readout circuit 40. The operation after time t11 is the same as the operation after time t1.

As described above, the control signal pSEL of each row is supplied at a constant interval. For example, the period (t2 to t5) from the control signal pSEL[1] to the control signal pSEL[2] is the same as the period (t5 to t7) from the control signal pSEL[2] to the control signal pSEL[3]. In each row, the period from the control signal pSEL to the control signal P_VSEL is the same. For example, the period (t2 to t3) from the control signal pSEL[1] to the control signal P_VSEL[1] is the same as the period (t5 to t6) from the control signal pSEL[2] to the control signal P_VSEL[2]. In each row, the period from the control signal P_VSEL to the first pulse P_CLK is constant. In FIG. 6, the timing of the control signal P_VSEL is the same as the timing of the first pulse P_CLK.

Thus, in each row, the period from the control signal pSEL to the control signal P_VSEL and the period from the control signal P_VSEL to the pulse P_CLK are the same. Accordingly, in each row, the period from the control signal pSEL to the pulse P_CLK becomes the same.

The time t3 is a timing at which the supply of the pulse P_CLK[1] to the first row is started, and the time t6 is a timing at which the supply of the pulse P_CLK[2] to the second row is started. The difference between these timings (t3-t6) corresponds to the difference between the timing (t2) at which the control signal pSEL[1] is supplied to the first row and the timing (t5) at which the control signal pSEL[2] is supplied to the second row.

As described above, in the adjacent rows, the difference (t3-t6) between the timings of the pulses P_CLK corresponds to the difference (t2-t5) between the timings of the control signals pSEL. As a result, the scanning rate at which the count value of the pixels in each row is output to the readout circuit 40 and the scanning rate at which the supply of the pulse P_CLK to the pixels in each row is started are the same. Thus, the accumulation period (for example, t3 to t12) of the count values in each row can be increased. Here, if the scanning rate of reading is different from the scanning rate at which the supply of the pulse P_CLK is started, the accumulation period is shortened. On the other hand, according to the present embodiment, since the scanning rate of the readout and the scanning rate at which the supply of the pulse P_CLK is started can be the same, even when the pixel P does not have a memory function for holding the accumulated data, the accumulation period of the count value can be lengthened.

The difference between the timing (t3) at which the supply of the pulse P_CLK[1] to the first row is started and the timing (t10) at which the supply of the pulse P_CLK[N] to the last row is started is equal to or larger than the period of the pulse P_CLK. The increase in the interval between the pulse P_CLK[1] and the pulse P_CLK[N] can suppress an increase in peak current and stabilize the operation of the device.

The difference between the timing (t3) at which the supply of the pulse P_CLK[1] to the first row is started and the timing (t6) at which the supply of the pulse P_CLK[2] to the second row is started is a non-integer multiple of the period of the pulse P_CLK. The same applies to the third to N-th rows. In each row, since the timing of the pulse P_CLK is different, the timing of the charge current is dispersed. This also makes it possible to suppress an increase in peak current.

### Second Embodiment

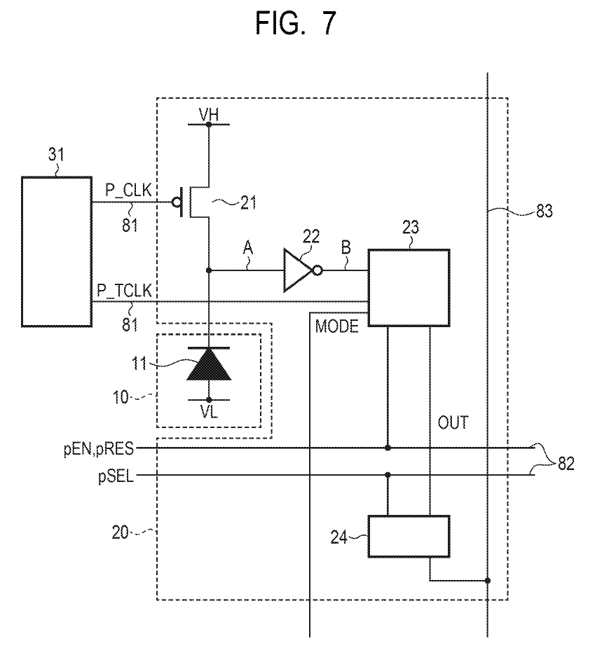

FIG. 7 is a block diagram of a pixel P according to the present embodiment. The same components as those of the first embodiment are denoted by the same reference numerals, and detailed description thereof will be omitted. The present embodiment differs from the first embodiment in that the count value is weighted.

The vertical scanning circuit 30 supplies a high-level or low-level control signal MODE to the counter 23. The control signal MODE is for setting weighting by the counter 23. When the control signal MODE is at high level, the counter 23 weights the count value, and when the control signal MODE is at low level, the counter 23 does not weight the count value.

The generation unit 31 supplies the pulse P_TCLK to the counter 23 after a predetermined time has elapsed from the supply of the pulse P_CLK to the switch 21. The pulse P_TCLK is for weighting the count value according to the incident time of the photon, and is supplied at a predetermined period.

When weighting the count value, the counter 23 counts the pulse P_TCLK from the generation unit 31. When the count value is not weighted, the counter 23 counts the pulse signal from the waveform shaping circuit 22 without counting the pulse P_TCLK.

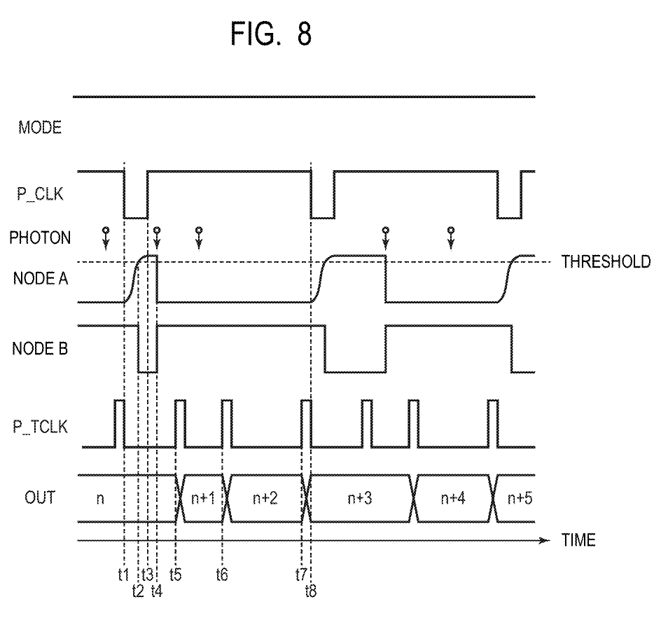

FIG. 8 is a timing chart illustrating the operation of the pixel P according to the present embodiment. FIG. 8 illustrates the control signal MODE, the pulse P_CLK, the photon, the voltage of the node A, the voltage of the node B, the pulse P_TCLK, and the count value OUT. In FIG. 8, the control signal MODE is at high level, and the counter 23 weights the count value.

The operation from time t1 to time t3 is the same as the operation from time t1 to time t3 in FIG. 5. At time t4, when a photon is incident on the APD 11, an avalanche current flows through the APD 11, and the voltage of the cathode of the APD 11, that is, the voltage of the node A drops. When the voltage of the node A becomes equal to or lower than the threshold value, the voltage of the node B of the waveform shaping circuit 22 is inverted and changes from low level to high level. The counter 23 receives a high-level signal from the node B of the waveform shaping circuit 22, and counts the pulse P_TCLK input during the high-level period of the node B. For example, the counter 23 counts the pulse P_TCLK at time t5, and counts up the count value from (n) to (n+1). Similarly, the counter 23 counts the pulse P_TCLK at times t6 and t7, and counts up the count value from (n+1) to (n+3). Thus, the count value (n) is counted up to the count value (n+3) by weighting the count value. When the count value is not weighted, the count value increases by 1 LSB, and the count value (n) becomes the count value (n+1).

At time t8, when the pulse P_CLK changes from high level to low level, the switch 21 is turned on, and the charge current for compensating the voltage drop is supplied from the power supply node at the voltage VH to the cathode of the APD 11. When the charge current is supplied, the voltage of the cathode of the APD 11, that is, the voltage of the node A of the waveform shaping circuit 22 starts to rise. The operation after time t8 is the same as the operation from time t1 to time t7.

As the illuminance of the object increases, that is, as the number of incident photons increases, the timing at which the first photon is incident after the pulse P_CLK tends to be earlier. As the timing at which the photon is incident after the pulse P_CLK becomes earlier, the period in which the voltage of the node B is at high level becomes longer. Since the pulse P_TCLK is counted when the voltage of the node B is at high level, the count value becomes larger as the period in which the voltage of the node B is at high level becomes longer. In other words, the closer the timing at which the node B outputs a high-level signal is to the supply timing of the pulse P_CLK, the larger the count value becomes. Thus, the counter 23 weights the count value according to the timing at which high level is output from the node B.

An expected value of the number of photons can be obtained from the count value by weighting. As the timing (t5) of the first pulse P_TCLK approaches the timing (t3) of the rising edge of the pulse P_CLK, the expected value of the number of photons increases, and the dynamic range can be extended.

Incidentally, as illustrated in FIG. 6, when the count value is weighted in the operation mode (out-of-phase mode) in which the timing of the pulse P_CLK of each row is different, there are two problems in that the accuracy of the count value is lowered.

The first problem is the influence of crosstalk on the correction processing. In crosstalk, for example, electrons in an n-th row generated by incidence of photons may leak to a pixel P in a row (for example, an (n+1)-th row) adjacent to the n-th row, and may be falsely counted in the pixel P in the (n+1)-th row. In order to correct the erroneous count, it is important to detect the erroneous count of the pixels P in the (n+1)-th row and then subtract the erroneous count value from the count value of the pixels P in the (n+1)-th row. If the erroneous count value of the pixel P in the (n+1)-th row is the same as the count value of the pixel P in the n-th row, it is easy to calculate the erroneous count value. However, when the timing of the pulse P_CLK of each row is different, the timing of the pulse P_TCLK of each row is also different and the weighting is also different. Therefore, the erroneous count value of the pixel P in the (n+1)-th row is different from the count value of the pixel P in the n-th row. When the count value of the pixel P in the n-th row is used for correction, it is necessary to consider the amount of deviation of the timing of the pulse P_CLK in the n-th row and the (n+1)-th row, and thus it becomes difficult to perform correction.

The second problem may occur when the light source of the imaging device blinks at a period corresponding to an integral multiple of the period of the pulse P_CLK. In this case, when the imaging device is driven in the out-of-phase mode, the amount of shift of the pulse P_CLK of each row with respect to the emission timing of the light source is different, and thus the count value of the weighting by the pulse P_TCLK is also different for each row.

On the other hand, there are two cases in which the out-of-phase mode is preferable when weighting the count value depending on the imaging condition.

The first case is that the illuminance of the object is high. The higher the illuminance, the more frequently the charging operation to the APD 11 occurs, and since the charging current flows each time, the peak value of the consumption current becomes larger, and there is a possibility that the stability of the operation of the device is impaired. When the illuminance of the object is equal to or higher than the reference value, the stability of the operation of the device is prioritized over the above two problems, and thus the out-of-phase mode is preferable. In the case of the out-of-phase mode, the timing of the pulse P_CLK is shifted in each row, and the timing of supplying the charge current is shifted. As a result, the peak value of the consumption current is reduced, and the operation of the device is stabilized.

The second case is a case where the light source does not blink at a period corresponding to an integral multiple of the period of the pulse P_CLK, and crosstalk is suppressed by the vertical scanning circuit 30 performing a decimation process. The vertical scanning circuit 30 can execute a decimation process of decimating rows every N rows (N is a natural number) and supplying the control signal pSEL to the pixels P. In this case, even if the count value is weighted, the above two problems are unlikely to occur, and thus the out-of-phase mode is preferable.

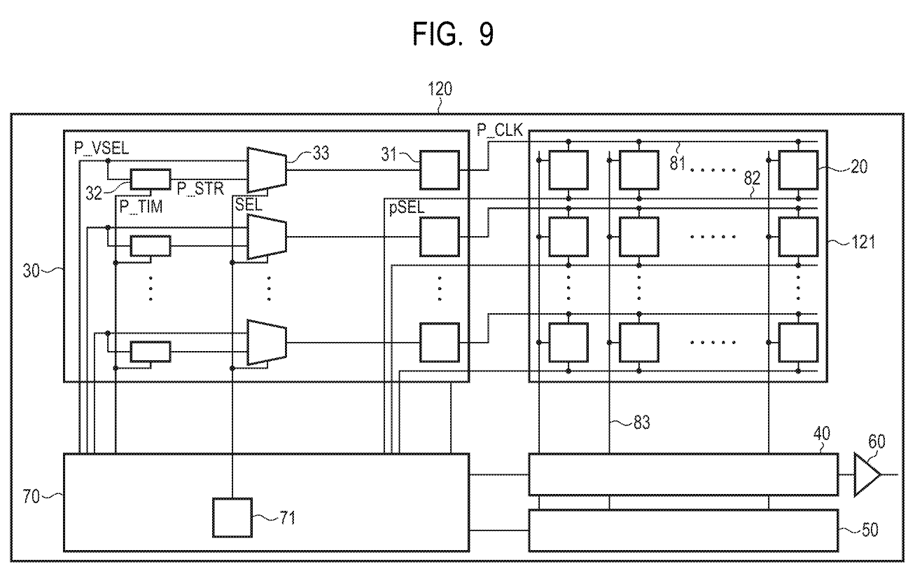

FIG. 9 is a block diagram of a circuit substrate 120 according to the present embodiment. In the present embodiment, by switching between the out-of-phase mode and an in-phase mode, it is possible to suppress a decrease in accuracy of the count value while stabilizing the operation of the device. In the out-of-phase mode, as described above, the timings of the pulses P_CLK of the respective rows are different from each other. In the in-phase mode, the timing of the pulse P_CLK of each row is synchronized with the reference pulse P_TIM of a predetermined period. The reference pulse P_TIM is supplied to the vertical scanning circuit 30 at the same period as the pulse P_CLK.

The vertical scanning circuit 30 includes a plurality of generation units 31, a plurality of timing adjustment units 32, and a plurality of signal selection units 33. The timing adjustment unit 32 and the signal selection unit 33 are disposed for each generation unit 31.

The control circuit 70 supplies the control signal P_VSEL and the reference pulse P_TIM to the timing adjustment unit 32. The reference pulse P_TIM is periodically supplied.

The timing adjustment unit 32 receives the control signal P_VSEL (asynchronous signal) and the reference pulse P_TIM from the control circuit 70, and generates the control signal P_STR (synchronous signal). The control signal P_VSEL is for not synchronizing the pulse P_CLK in each row. The control signal P_STR is for synchronizing the pulse P_CLK in each row. The control signal P_STR indicates the timing of the reference pulse P_TIM supplied immediately after the control signal P_VSEL. The timing adjustment unit 32 supplies the control signal P_STR to the signal selection unit 33.

The control circuit 70 includes a setting unit 71, and the setting unit 71 supplies the control signal SEL to the signal selection units 33 of all rows. The control signal SEL is for selecting the control signal P_VSEL or the control signal P_STR. In the in-phase mode, the control signal SEL indicates selection of the control signal P_STR, and in the out-of-phase mode, the control signal SEL indicates selection of the control signal P_VSEL.

The signal selection unit 33 receives the control signals P_STR, P_VSEL, and SEL, selects one of the control signal P_STR and the control signal P_VSEL based on the control signal SEL, and supplies the selected control signal to the generation unit 31. The signal selection unit 33 supplies the control signal P_STR to the generation unit 31 in the in-phase mode, and supplies the control signal P_VSEL to the generation unit 31 in the out-of-phase mode.

The generation unit 31 starts generation of the pulse P_CLK at a timing when one of the control signal P_STR and the control signal P_VSEL is input. The generation unit 31 periodically supplies the pulse P_CLK to the pixel P.

Thus, the photoelectric conversion device 100 switches the generation unit 31 to the in-phase mode or the out-of-phase mode based on the control signal SEL.

Note that the control circuit 70 determines whether or not the illuminance (light source) of the object changes (blinks) at a period corresponding to an integral multiple of the period of the pulse P_CLK based on the imaging signal of the object or the signal indicating the light emission period of the light source.

Further, the control circuit 70 determines whether or not the illuminance of the object is equal to or higher than a reference value based on the imaging signal of the object.

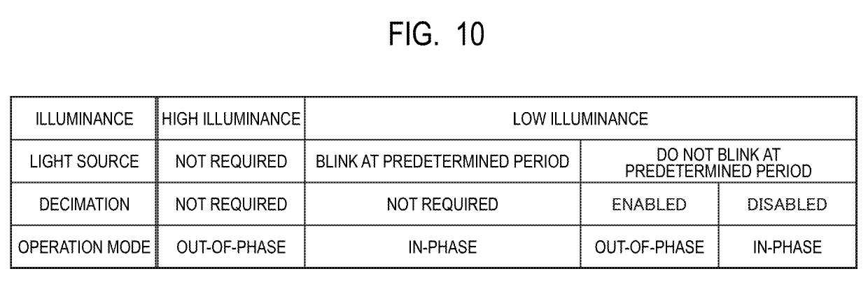

FIG. 10 is a diagram illustrating switching conditions of the in-phase mode and the out-of-phase mode according to the present embodiment. When the illuminance of the object is high illuminance equal to or higher than the reference value, the setting unit 71 supplies a control signal SEL indicating selection of the control signal P_VSEL to the signal selection unit 33. The generation unit 31 receives the control signal P_VSEL from the signal selection unit 33 and operates in the out-of-phase mode.

When the illuminance is low illuminance less than the reference value and the illuminance (light source) changes (blinking) at a period corresponding to an integral multiple of the period of the pulse P_CLK, the setting unit 71 supplies a control signal SEL indicating selection of the control signal P_STR to the signal selection unit 33. The generation unit 31 receives the control signal P_STR from the signal selection unit 33 and operates in the in-phase mode.

In a case where the illuminance is low and the illuminance (light source) changes (blinking) at a period not corresponding to an integral multiple of the period of the pulse P_CLK and the vertical scanning circuit 30 performs the decimation process, the setting unit 71 supplies the control signal SEL indicating selection of the control signal P_VSEL to the signal selection unit 33. The generation unit 31 receives the control signal P_VSEL from the signal selection unit 33 and operates in the out-of-phase mode.

When the illuminance is low, the illuminance (light source) changes (blinking) at a period not corresponding to an integral multiple of the period of the pulse P_CLK, and the vertical scanning circuit 30 does not perform the decimation process, the setting unit 71 supplies the control signal SEL indicating selection of the control signal P_STR to the signal selection unit 33. The generation unit 31 receives the control signal P_STR from the signal selection unit 33 and operates in the in-phase mode.

Thus, the in-phase mode and the out-of-phase mode are switched depending on the imaging conditions. Accordingly, the photoelectric conversion device 100 can suppress the influence of the above two problems while ensuring the stability of the operation of the device when weighting the count values. In the present embodiment, the switching between the in-phase mode and the out-of-phase mode is not performed for each row, but is performed for all rows.

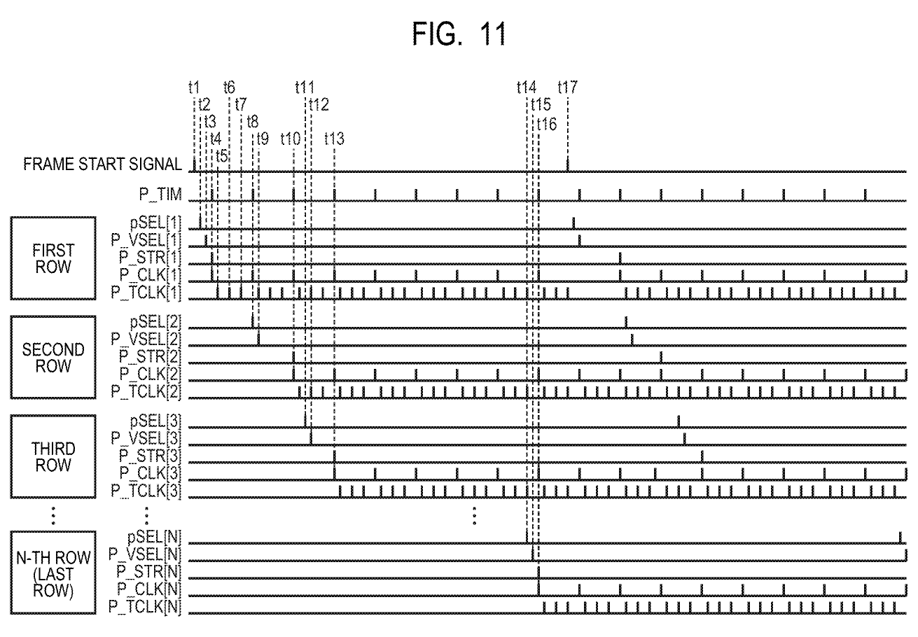

FIG. 11 is a timing chart illustrating the operation of the photoelectric conversion device 100 in the in-phase mode according to the present embodiment. FIG. 11 illustrates a frame start signal, a reference pulse P_TIM, control signals pSEL, P_VSEL, P_STR, and pulses P_CLK and P_TCLK. Among the first to N-th (last) rows of the pixel array, the first, second, third, and N-th (last) rows are illustrated. When the control signal pSEL is supplied to the first row, it is referred to as a control signal pSEL[1]. The control signals P_VSEL, P_STR, and the pulses P_CLK, P_TCLK are similarly described.

At time t1, the control circuit 70 supplies a frame start signal indicating the start of generation of the first frame to the vertical scanning circuit 30. The vertical scanning circuit 30 receives the frame start signal and starts generating the first frame.

At time t2, the control circuit 70 supplies the control signal pSEL[1] to the vertical scanning circuit 30. The vertical scanning circuit 30 supplies the control signal pSEL[1] from the control circuit 70 to the pixels P in the first row. The pixels P in the first row receive the control signal pSEL[1], and the counter 23 outputs the count value to the readout circuit 40.

At time t3, the control circuit 70 supplies the control signal P_VSEL[1] to the timing adjustment unit 32 and the signal selection unit 33 of the pixel P in the first row.

At time t4, the timing adjustment unit 32 generates the control signal P_STR[1] at the timing of the reference pulse P_TIM supplied immediately after the control signal P_VSEL[1] and supplies the control signal P_STR[1] to the signal selection unit 33. Thus, the timing of supplying the control signal P_STR[1] is after the timing of supplying the control signal P_VSEL[1]. The signal selection unit 33 selects the control signal P_STR[1] based on the control signal SEL from among the control signals P_STR[1] and P_VSEL[1] and supplies the control signal P_STR[1] to the generation unit 31. The generation unit 31 receives the control signal P_STR[1] and starts supplying the pulse P_CLK[1] to the pixels P in the first row. The pulse P_CLK[1] is synchronized with the reference pulse P_TIM. As described above, the generation unit 31 in the first row operates in the in-phase mode.

At time t5, the generation unit 31 starts supplying the pulse P_TCLK[1] to the pixels P in the first row after a predetermined time elapses from the pulse P_CLK[1].

The generation unit 31 supplies the pulse P_TCLK[1] to the pixels P in the first row at time t6, and supplies the pulse P_TCLK[1] to the pixels P in the first row at time t7. The timing of each pulse P_TCLK with reference to the timing of the pulse P_CLK is the same for all rows.

At time t8, the generation unit 31 supplies the pulse P_CLK[1] to the pixels P in the first row. The pulse P_CLK[1] is synchronized with the reference pulse P_TIM. At time t8, the control circuit 70 supplies the control signal pSEL[2] to the vertical scanning circuit 30. The vertical scanning circuit 30 supplies the control signal pSEL[2] from the control circuit 70 to the pixels P in the second row. The pixels P in the second row receive the control signal pSEL[2], and the counter 23 outputs the count value to the readout circuit 40.

At time t9, the control circuit 70 supplies the control signal P_VSEL[2] to the timing adjustment unit 32 and the signal selection unit 33 of the pixel P in the second row.

At time t10, the timing adjustment unit 32 generates the control signal P_STR[2] at the timing of the reference pulse P_TIM supplied immediately after the control signal P_VSEL[2] and supplies the control signal P_STR[2] to the signal selection unit 33. The signal selection unit 33 selects the control signal P_STR[2] based on the control signal SEL from among the control signals P_STR[2] and P_VSEL[2] and supplies the control signal P_STR[2] to the generation unit 31. The generation unit 31 receives the control signal P_STR[2] and starts supplying the pulse P_CLK[2] to the pixels P in the second row. The pulse P_CLK[2] is synchronized with the reference pulse P_TIM. As described above, the generation unit 31 in the second row operates in the in-phase mode.

The operation of the third row from time t11 to time t13 and the operation of the N-th row from time t14 to time t16 are the same as the operation in the second row from time t8 to time t10 in FIG. 11.

At time t17, the control circuit 70 supplies a frame start signal indicating the start of generation of the second frame to the vertical scanning circuit 30. The pixels P in each row receive the control signal pSEL supplied after time t17, and output the count value of the first frame from the counter 23 to the readout circuit 40. The operation after time t17 is the same as the operation after time t1 in FIG. 11.

Thus, the photoelectric conversion device 100 operates in the in-phase mode according to the imaging condition when weighting the count value. In the case of the in-phase mode, since the pulse P_CLK of each row is synchronized with the reference pulse P_TIM, the pulse P_TCLK of each row is also synchronized with the reference pulse P_TIM. As a result, the crosstalk correction process is facilitated, and even when the illuminance (light source) changes (blinking) at a period corresponding to an integral multiple of the period of the pulse P_CLK, it is possible to suppress the difference in the count value of the weighting between the rows.

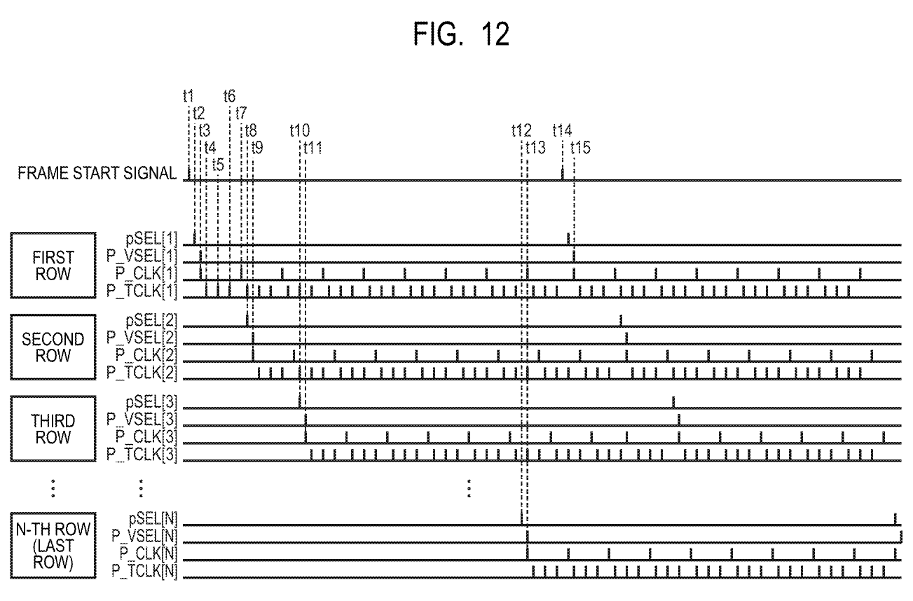

FIG. 12 is a timing chart illustrating the operation of the photoelectric conversion device 100 in the out-of-phase mode according to the present embodiment. FIG. 12 illustrates timings of the frame start signal, the control signals pSEL and P_VSEL, and the pulses P_CLK and P_TCLK. Among the first to N-th (last) rows of the pixel array, the first, second, third, and N-th (last) rows are illustrated.

The operation from time t1 to time t3 is the same as the operation from time t1 to time t3 in FIG. 6. At time t4, the generation unit 31 starts supplying the pulse P_TCLK[1] to the pixels P in the first row after a predetermined time elapses from the pulse P_CLK[1].

The generation unit 31 supplies the pulse P_TCLK[1] to the pixels P in the first row at time t5, and supplies the pulse P_TCLK[1] to the pixels P in the first row at time t6. Note that, similarly to the operation of FIG. 11, the timing of each pulse P_TCLK with reference to the timing of the pulse P_CLK is the same in all rows.

The operation from time t7 to time t14 is the same as the operation from time t4 to time t11 in FIG. 6. As described above, the photoelectric conversion device 100 operates in the out-of-phase mode according to the imaging condition when weighting the count value. In the case of the out-of-phase mode, since the timings of the pulses P_CLK of the respective rows are different from each other, the supply timings of the charge currents of the respective rows are different from each other, and the power concentration is suppressed.

As described above, according to the present embodiment, the time t3 is the timing at which the control signal P_VSEL[1] is supplied to the pixels P in the first row, and the time t9 is the timing at which the control signal P_VSEL[2] is supplied to the pixels P in the second row. The difference (t3-t9) between these timings corresponds to the difference between the timing (t2) at which the control signal pSEL[1] is supplied to the pixels P in the first row and the timing (t8) at which the control signal pSEL[2] is supplied to the pixels P in the second row.

Thus, in the adjacent rows, the difference (t3-t9) between the timings of the control signals P_VSEL corresponds to the difference (t2-t8) between the timings of the control signals pSEL. As a result, in the out-of-phase mode, the scanning rate at which the count values of the pixels in each row are output to the readout circuit 40 is the same as the scanning rate at which the supply of the pulse P_CLK to the pixels in each row is started. Accordingly, the accumulation time (for example, t3 to t15) of the count values in each row can be increased.

The difference between the timing (t3) at which the supply of the pulse P_CLK[1] to the pixel P in the first row is started and the timing (t13) at which the supply of the pulse P_CLK[N] to the pixel P in the last row is started is equal to or larger than the period of the pulse P_CLK. By increasing the interval between the pulse P_CLK[1] and the pulse P_CLK[N], the photoelectric conversion device 100 can suppress power concentration and can stabilize the operation of the device.

### Third Embodiment

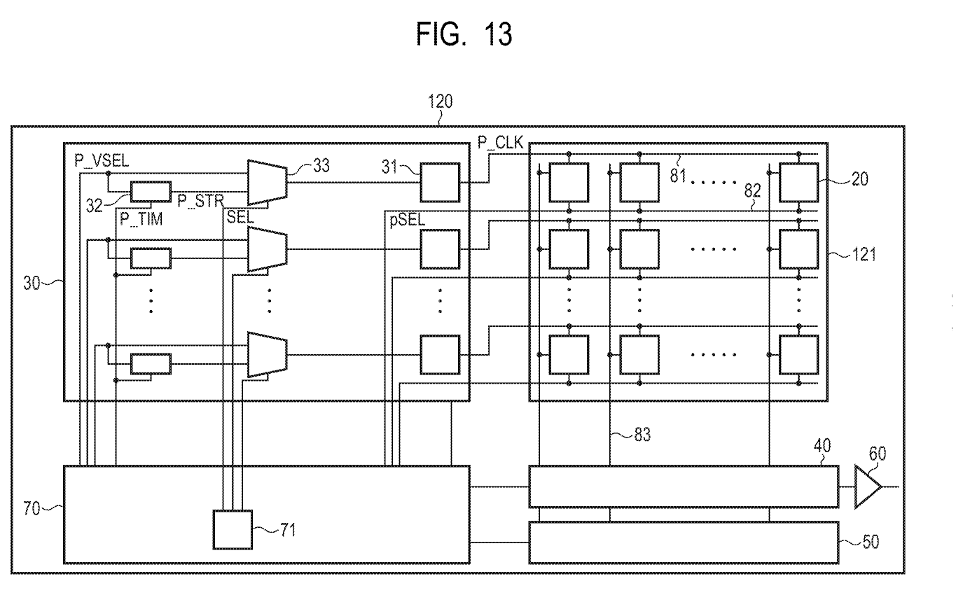

FIG. 13 is a block diagram of a circuit substrate 120 according to the present embodiment. The same components as those of the second embodiment are denoted by the same reference numerals, and detailed description thereof will be omitted. The present embodiment is different from the second embodiment in that switching between the in-phase mode and the out-of-phase mode is performed for each row.

The setting unit 71 supplies the control signal SEL for each row. For example, the setting unit 71 individually supplies the control signal SEL to the signal selection unit 33 of each row, and performs switching between the in-phase mode and the out-of-phase mode for each row.

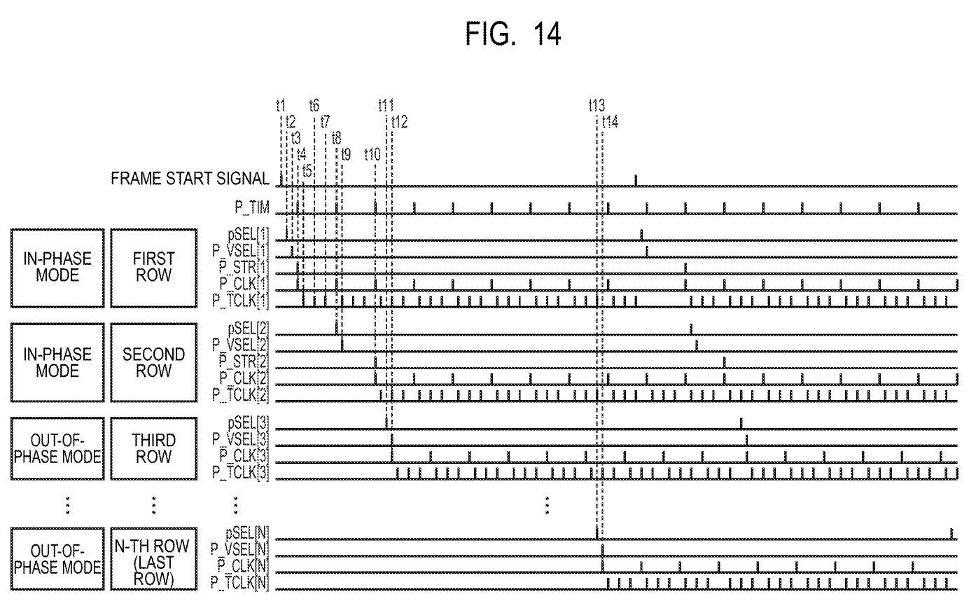

FIG. 14 is a timing chart illustrating the operation of the photoelectric conversion device 100 according to the present embodiment. In FIG. 14, the first row and the second row are set to the in-phase mode, and the third row and the N-th row are set to the out-of-phase mode. The same signals as in FIG. 11 are illustrated in the first row and the second row of FIG. 14, and the same signals as in FIG. 12 are illustrated in the third row and the N-th row of FIG. 14.

The operation from time t1 to time t10 is the in-phase mode, and is the same as the operation from time t1 to time t10 in FIG. 11.

The operation from time t11 to time t14 is the out-of-phase mode, and is the same as the operation from time t10 to time t13 in FIG. 12.

In each row, switching between the in-phase mode and the out-of-phase mode may be performed based on the imaging conditions of FIG. 10.

As described above, according to the present embodiment, since the setting unit 71 supplies the control signal SEL for each row, the in-phase mode and the out-of-phase mode can be switched for each row. Thus, the photoelectric conversion device 100 according to the present embodiment can accurately suppress the influence of the two problems described above as compared with the second embodiment.

### Fourth Embodiment

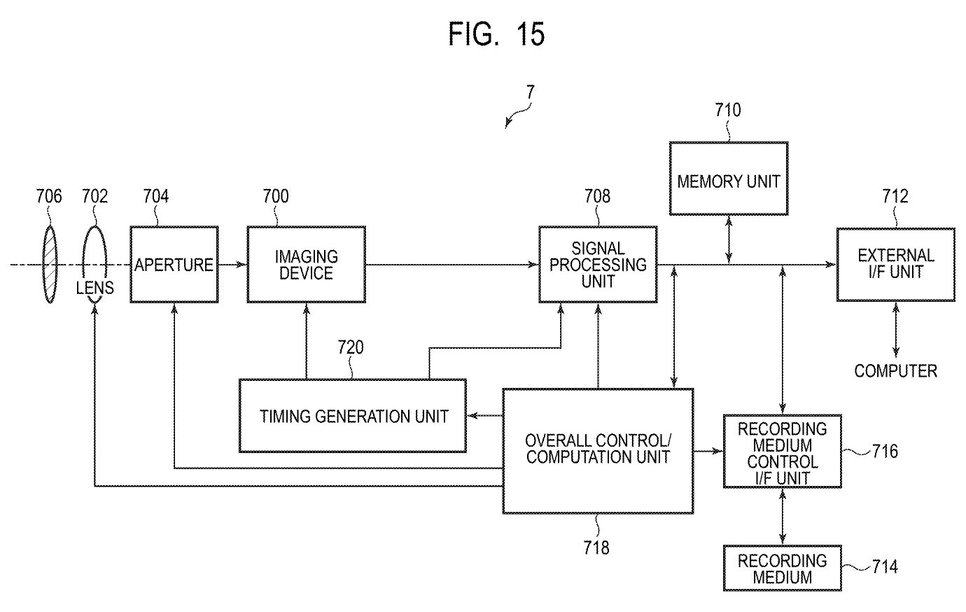

The photoelectric conversion device 100 in the above-described embodiment can be applied to various equipment. Examples of the equipment include a digital still camera, a digital camcorder, a camera head, a copier, a fax machine, a mobile phone, an in-vehicle camera, an observation satellite, and a monitoring camera. FIG. 15 is a block diagram of a digital still camera as an example of the equipment.

The equipment 7 illustrated in FIG. 15 includes a barrier 706, a lens 702, an aperture 704, and an imaging device 700 (an example of a photoelectric conversion device). The equipment 7 further includes a signal processing unit (processing device) 708, a timing generation unit 720, an overall control/computation unit 718 (control device), a memory unit 710 (storage device), a recording medium control I/F unit 716, a recording medium 714, and an external I/F unit 712. At least one of the barrier 706, the lens 702, and the aperture 704 is an optical device corresponding to the equipment 7. The barrier 706 protects the lens 702, and the lens 702 forms an optical image of an object on the imaging device 700. The aperture 704 makes the amount of light passing through the lens 702 variable. The imaging device 700 is configured as in the above-described embodiment, and converts an optical image formed by the lens 702 into image data (image signal). The signal processing unit 708 performs various corrections, data compression, and the like on the imaging data output from the imaging device 700. The timing generation unit 720 outputs various timing signals to the imaging device 700 and the signal processing unit 708. The overall control/computation unit 718 controls the entire digital still camera, and the memory unit 710 temporarily stores image data. The recording medium control I/F unit 716 is an interface for recording or reading image data on or from the recording medium 714, and the recording medium 714 is a detachable recording medium such as a semiconductor memory for recording or reading imaging data. The external I/F unit 712 is an interface for communicating with an external computer or the like. The timing signal and the like may be input from the outside of the equipment 7. The equipment 7 may further include a display device (a monitor, an electronic viewfinder, or the like) that displays information obtained by the imaging device 700. The equipment 7 includes at least one photoelectric conversion device. Further, the equipment 7 includes at least one of an optical device, a control device, a processing device, a display device, a storage device, and a mechanical device that operates based on information obtained by the photoelectric conversion device. The mechanical device is a movable unit (for example, a robot arm) that operates by receiving a signal of the photoelectric conversion device.

Each pixel may include a plurality of photoelectric conversion units (a first photoelectric conversion unit and a second photoelectric conversion unit). The signal processing unit 708 may be configured to process the pixel signal based on the charge generated in the first photoelectric conversion unit and the pixel signal based on the charge generated in the second photoelectric conversion unit, and acquire the distance information from the imaging device 700 to the object.

### Fifth Embodiment

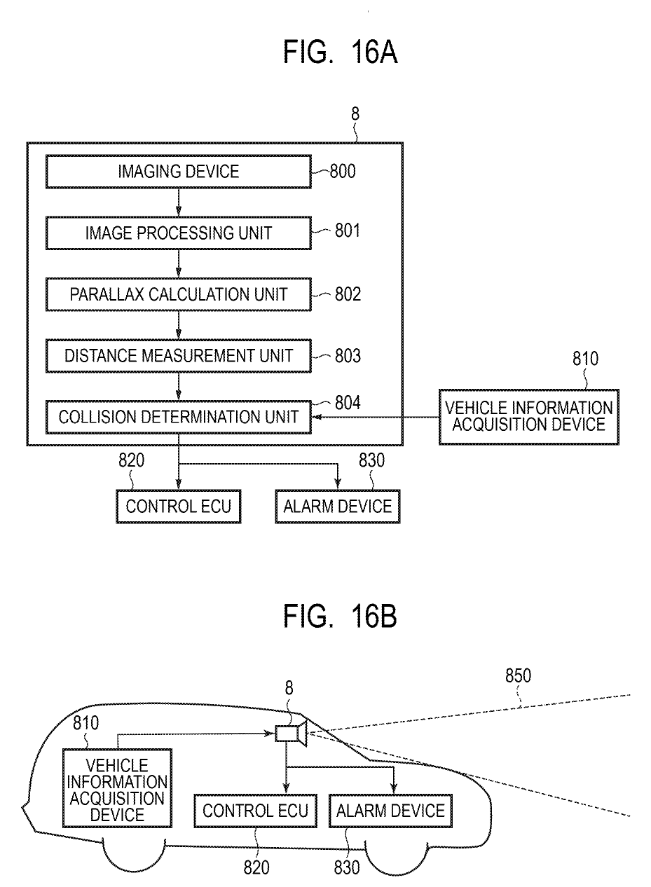

FIGS. 16A and 16B are block diagrams of an equipment 8 related to an in-vehicle camera according to the present embodiment. The equipment 8 includes an imaging device 800 (an example of a photoelectric conversion device) and a signal processing device that processes a signal from the imaging device 800. The equipment 8 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 8. In addition, the equipment 8 includes a distance measurement unit 803 that calculates a distance to the object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to an object. That is, the distance information is information related to a parallax, a defocus amount, a distance to an object, and the like. The collision determination unit 804 may determine the collision possibility using any of these pieces of distance information. The distance information acquisition unit may be realized by dedicatedly designed hardware or may be realized by a software module. Also, it may be realized by FPGA (Field Programmable Gate Array), ASIC (Application Specific Integrated Circuit) or a combination thereof.

The equipment 8 is connected to the vehicle information acquisition device 810, and can acquire vehicle information such as a vehicle speed, a yaw rate, and a steering angle. In addition, a control ECU 820, which is a control device that outputs a control signal for generating a braking force to the vehicle based on the determination result of the collision determination unit 804, is connected to the equipment 8. The equipment 8 is also connected to an alarm device 830 that issues a warning to the driver based on the determination result of the collision determination unit 804. For example, when the determination result of the collision determination unit 804 indicates that the possibility of collision is high, the control ECU 820 performs vehicle control to avoid collision and reduce damage by, for example, applying a brake, returning an accelerator, or suppressing engine output. The alarm device 830 gives a warning to the user by sounding a warning such as a sound, displaying warning information on a screen of a car navigation system or the like, giving vibration to a seat belt or a steering wheel, or the like. The equipment 8 functions as a control unit that controls the operation of controlling the vehicle as described above.

In the present embodiment, the surroundings of the vehicle, for example, the front or rear is imaged by the equipment 8. FIG. 16B illustrates a device in a case of capturing an image in front of the vehicle (imaging range 850). The vehicle information acquisition device 810 serving as the imaging control means sends an instruction to the equipment 8 or the imaging device 800 to perform the imaging operation. With such a configuration, the accuracy of distance measurement can be further improved.

In the above description, an example in which control is performed so as not to collide with another vehicle has been described, but the present disclosure is also applicable to control in which automatic driving is performed so as to follow another vehicle, control in which automatic driving is performed so as not to protrude from a lane, and the like. Further, the equipment 8 is not limited to a vehicle such as an automobile, and can be applied to, for example, a ship, an aircraft, an artificial satellite, an industrial robot, a consumer robot, or the like mobile object (mobile device). In addition, the present disclosure is not limited to mobile objects, and can be widely applied to devices utilizing object recognition or biometric recognition, such as an Intelligent Transport Systems (ITS) and a monitoring system.

### Modified Embodiments

The present disclosure is not limited to the above embodiment, and various modifications are possible. For example, an example in which a partial configuration of one embodiment is added to another embodiment or an example in which a partial configuration of one embodiment is replaced with a partial configuration of another embodiment is also an embodiment of the present disclosure.

For example, although an example in which the switch 21 is connected to the cathode of the APD 11 has been described, the present disclosure is not limited thereto, and the switch may be connected to the anode of the APD 11.

The signal processing unit 20 does not necessarily have to be provided for each of all the pixels P, for example, one signal processing unit 20 may be shared by a plurality of pixels P and signal processing may be sequentially performed.

In the present embodiment, the counter 23 is used. However, instead of the counter 23, a time-to-digital conversion circuit (Time-to-Digital Converter: TDC) and a memory may be used to obtain the pulse detection timing in the photoelectric conversion device 100. At this time, the generation timing of the pulse signal supplied from the waveform shaping circuit 22 is converted into a digital signal by the TDC. A control signal pREF (reference signal) is supplied to the TDC from the vertical scanning circuit 30 in order to measure the timing of the pulse signal. The TDC acquires, as a digital signal, a signal when an input timing of a signal supplied from each pixel P via the waveform shaping circuit 22 is set to a relative time with reference to the control signal pREF.

According to the present disclosure, it is possible to realize a photoelectric conversion device capable of suppressing a reduction in the accumulation period of count values.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066959, filed Apr. 15, 2025, which is hereby incorporated by reference herein in its entirety.

What is claimed is:

1. A photoelectric conversion device comprising:
a plurality of pixels each including an avalanche photodiode, a charge circuit, and a counter and arranged in a matrix; and
a scanning circuit configured to supply a charge pulse for controlling the charge circuit and a readout signal for reading out a count value of the counter to the pixels in each row,
wherein the charge circuit is configured to set one node of the avalanche photodiode to a charge state or a floating state in response to the charge pulse supplied at a predetermined period,
wherein the counter is configured to count a signal obtained by avalanche multiplication of the avalanche photodiode in the floating state, and
wherein a difference between a timing at which the supply of the charge pulse to the pixels in a first row is started and a timing at which the supply of the charge pulse to the pixels in a second row is started corresponds to a difference between a timing at which the readout signal is supplied to the pixels in the first row and a timing at which the readout signal is supplied to the pixels in the second row.

2. The photoelectric conversion device according to claim 1, wherein a difference between a timing at which the supply of the charge pulse to the pixels in an initial row is started and a timing at which the supply of the charge pulse to the pixels in a last row is started is equal to or larger than the period.

3. The photoelectric conversion device according to claim 1, wherein a difference between the timing at which the supply of the charge pulse to the pixels in the first row is started and the timing at which the supply of the charge pulse to the pixels in the second row is started is a non-integer multiple of the period.

4. A photoelectric conversion device comprising:
a plurality of pixels each including an avalanche photodiode, a charge circuit, and a counter and arranged in a matrix; and
a scanning circuit configured to supply a charge pulse for controlling the charge circuit and a readout signal for reading out a count value of the counter to the pixels in each row,
wherein in response to a synchronous signal for synchronizing the charge pulses in each row or an asynchronous signal for not synchronizing the charge pulses in each row, the scanning circuit is configured to supply the charge pulse to the pixels in each row,
wherein the charge circuit is configured to set one node of the avalanche photodiode to a charge state or a floating state in response to the charge pulse supplied at a predetermined period,
wherein the counter is configured to count a signal obtained by avalanche multiplication of the avalanche photodiode in the floating state, and
wherein a difference between a timing of supplying the asynchronous signal to the pixels in a first row and a timing of supplying the asynchronous signal to the pixels in a second row corresponds to a difference between a timing of supplying the readout signal to the pixels in the first row and a timing of supplying the readout signal to the pixels in the second row.

5. The photoelectric conversion device according to claim 4, wherein the timing of supplying the synchronous signal is after the timing of supplying the asynchronous signal.

6. The photoelectric conversion device according to claim 5, wherein in a reference pulse which has the same period as the period of the charge pulse, the timing of the synchronous signal is the timing of the reference pulse supplied immediately after the asynchronous signal.

7. The photoelectric conversion device according to claim 4, wherein the counter weights the count value based on the timing at which the signal by the avalanche multiplication is output.

8. The photoelectric conversion device according to claim 7, wherein the counter increases the weighting as the timing at which the signal by the avalanche multiplication is output is closer to the timing at which the charge pulse is supplied.

9. The photoelectric conversion device according to claim 7, wherein the scanning circuit is configured to perform a decimation process of decimating the rows every N rows and supplying the readout signal to the pixels.

10. The photoelectric conversion device according to claim 9,
wherein the scanning circuit is configured to supply the charge pulse according to the asynchronous signal when an illuminance of an object is equal to or greater than a reference value, and
wherein the scanning circuit is configured to supply the charge pulse according to the synchronous signal when the illuminance is less than the reference value and the illuminance changes at a period corresponding to an integral multiple of the period of the charge pulse.

11. The photoelectric conversion device according to claim 10,
wherein the scanning circuit is configured to supply the charge pulse according to the asynchronous signal when the illuminance is less than the reference value, the illuminance changes at a period not corresponding to an integral multiple of the period of the charge pulse, and the scanning circuit performs the decimation process, and
wherein the scanning circuit is configured to supply the charge pulse according to the synchronous signal when the illuminance is less than the reference value, the illuminance changes at a period not corresponding to an integral multiple of the period of the charge pulse, and the scanning circuit does not perform the decimation process.

12. The photoelectric conversion device according to claim 4, wherein the asynchronous signal or the synchronous signal is supplied to each of the rows.

13. The photoelectric conversion device according to claim 4, wherein the asynchronous signal or the synchronous signal is supplied to all the rows.

14. The photoelectric conversion device according to claim 4,
wherein the scanning circuit includes a plurality of generation units configured to generate the charge pulse according to the synchronous signal or the asynchronous signal, and
wherein each of the plurality of generation units is provided for each of the rows.

15. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

16. The equipment according to claim 15, wherein the processing device is configured to acquire distance information from the photoelectric conversion device to an object.
